(19) United States
(12) Patent Application Publication
(10) Pub. No.: US 2011/0253706 A1
(43) Pub. Date: Oct. 20, 2011

(54) HEATING DEVICE WITH PLURAL INDUCTION COILS

(75) Inventors: Ming-Whang Wang, Taoyuan Hsien (TW); Yen-Po Chen, Taoyuan Hsien (TW)

(73) Assignee: DELTA ELECTRONICS, INC., Taoyuan Hsien (TW)

(21) Appl. No.: 13/040,911

(22) Filed: Mar. 4, 2011

(30) Foreign Application Priority Data
Apr. 15, 2010 (TW) 099111865

(51) Int. Cl. H05B 6/12; H05B 6/04

(52) U.S. Cl. 219/624; 219/660

(57) ABSTRACT

A heating device includes a first induction coil, a second induction coil, a first phase power unit, a second phase power unit, a power controller and a user interface unit. The second induction coil isn't always concentric with the first induction coil. The first phase power unit is connected with the first induction coil, and configured for receiving a first phase input voltage and outputting a first voltage. The second phase power unit is connected with the second induction coil, and configured for receiving a second phase input voltage and outputting a second voltage. There is a phase difference between the first phase input voltage and the second phase input voltage. The power controller is used for controlling operations of the first phase power unit and the second phase power unit. The user interface unit is connected with the power controller for controlling the power controller.

### FIELD OF THE INVENTION

The present invention relates to a heating device, and more particularly to a heating device with plural induction coils.

### BACKGROUND OF THE INVENTION

Nowadays, a variety of heating devices such as gas stoves, infrared oven, microwave oven and electric stove are widely used to cook food. Different heating devices have their advantages or disadvantages. Depending on the food to be cooked, a desired heating device is selected.

Take an induction cooking stove for example. When a current flows through the induction coil of the induction cooking stove, electromagnetic induction is performed to produce eddy current, thereby heating a foodstuff container. For simultaneously heating multiple foodstuff containers, the heating device needs to have multiple induction coils. By adjusting the electricity quantities to the induction coils, the heating temperatures of respective induction coils are determined.

FIG. 1 is a schematic diagram illustrating a heating device with two induction coils according to the prior art. As shown in FIG. 1, the heating device 1 comprises a first induction coil 11a and a second induction coil 11b. The first induction coil 11a and the second induction coil 11b are arranged at a first heating region A1 and a second heating region A2, respectively. A first foodstuff container 2a and a second foodstuff container 2b are respectively placed on the first heating region A1 and the second heating region A2 of the heating device 1. During operations of the heating device 1, the first foodstuff container 2a and the second foodstuff container 2b are respectively heated by the first foodstuff container 2a and the second foodstuff container 2b through electromagnetic induction.

However, in a case that the first induction coil 11a and the second induction coil 11b are used for heating a large-sized foodstuff container (not shown) through electromagnetic induction, the heating efficacy of the two induction coils 11a and 11b will be reduced because the large-sized foodstuff container fails to be effectively aligned with the two induction coils 11a and 11b. In other words, the heat quantity applied to the heating device 1 is not equal to the total heat quantity of the first induction coil 11a and the second induction coil 11b.

Generally, the conventional heating device 1 uses a single phase power supply for converting the input voltages into desired voltages required for powering the first induction coil 11a and the second induction coil 11b. In a case that the first induction coil 11a and the second induction coil 11b are simultaneously enabled to heat the foodstuff containers, the input current of the heating device 1 is too large. Due to the current limitation of the single phase power supply, the conventional heating device 1 fails to provide relatively high heat quantity or power (watt).

Therefore, there is a need of providing a heating device with plural induction coils so as to obviate the drawbacks encountered from the prior art.

### SUMMARY OF THE INVENTION

It is an object of the present invention to provide a heating device with plural induction coils by using a multi-phase input power supply, thereby increasing heat quantity or power. The heat device of the present invention can provide more heat quantity or power when compared with a conventional heating device using a single phase input power supply. The heating device of the present invention can provide more heat quantity or power to the induction coils because the currents flowing through the power wires are reduced.

It is another object of the present invention to provide a heating device with plural induction coils by using a multi-phase input power supply, wherein all phase power units of the heating device are controlled by a single power controller and the operating data of all phase power units can be acquired by the user interface unit. The use of the single power controller can reduce the overall cost of the heating device. The user interface unit can use simple algorithm to control the power controller while increasing the stability. Moreover, according to the size of the foodstuff container, the micro processor of the heating device will enable at least one of the phase power units, thereby selectively controlling operations of the induction coils. Therefore, the heating device of the present invention can be used to heat various foodstuff containers with different sizes.

It is a further object of the present invention to provide a heating device with plural induction coils by using a multi-phase input power supply. The foodstuff container can be effectively aligned with the induction coils of the heating device and the foodstuff container can be heated by the induction coils simultaneously. These induction coils are collectively defined as an equivalent induction coil for generating more heat quantity or power so that the heating efficacy of the induction coils can be enhanced. Moreover, the total heat quantity of the induction coils can be employed to heat a large-sized foodstuff container through electromagnetic induction.

In accordance with an aspect of the present invention, there is provided a heating device. The heating device includes a first induction coil, a second induction coil, a first phase power unit, a second phase power unit, a power controller and a user interface unit. The first phase power unit is connected with the first induction coil, and configured for receiving a first phase input voltage and outputting a first voltage. The second phase power unit is connected with the second induction coil, and configured for receiving a second phase input voltage and outputting a second voltage. There is a phase difference between the first phase input voltage and the second phase input voltage. The power controller is connected with the first phase power unit and the second phase power unit for controlling operations of the first phase power unit and the second phase power unit. The user interface unit is connected with the power controller for controlling the power controller.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating a heating device with two induction coils according to the prior art;

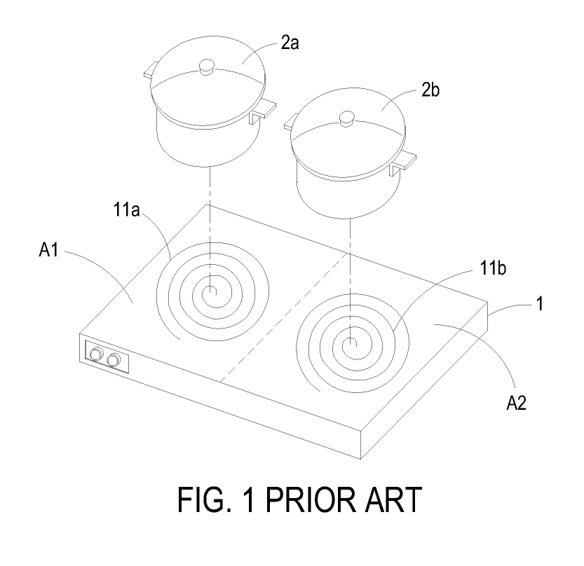

FIG. 2 is a schematic diagram illustrating a heating device with plural induction coils according to an embodiment of the present invention;

FIG. 3 is a schematic circuit block diagram illustrating a heating device with plural induction coils according to an embodiment of the present invention;

FIG. 4 is a schematic diagram illustrating a heating device with plural induction coils according to another embodiment of the present invention;

FIG. 5 is a schematic circuit block diagram illustrating a heating device with plural induction coils according to another embodiment of the present invention; and

FIG. 6 is a schematic circuit block diagram illustrating a heating device with plural induction coils according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

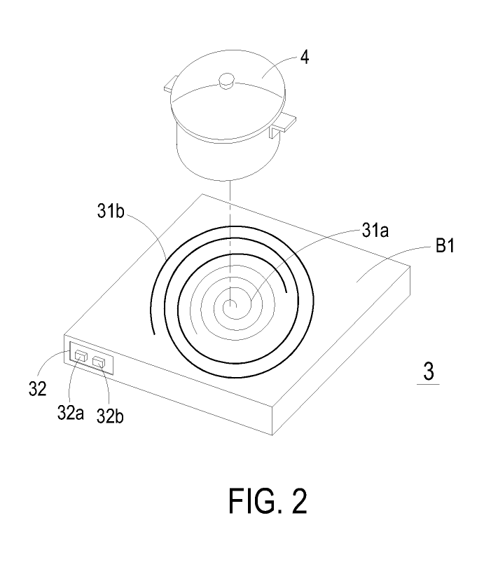

FIG. 2 is a schematic diagram illustrating a heating device with plural induction coils according to an embodiment of the present invention. As shown in FIG. 2, the heating device 3 comprises a first induction coil 31a, a second induction coil 31b and a user interface unit 32. The first induction coil 31a is arranged at an inner portion of a heating region B1. The second induction coil 31b is arranged at an outer portion of the heating region B1 so that the first induction coil 31a is surrounded by the second induction coil 31b. In an embodiment, the first induction coil 31a and the second induction coil 31b aren't always concentric with each other. Alternatively, the first induction coil 31a and the second induction coil 31b are concentric with each other. The heating device 3 is used for heating a foodstuff container 4 through electromagnetic induction.

The user interface unit 32 is disposed on a surface of the main body of the heating device 3. Through the user interface unit 32, a user's cooking option corresponding to the heating conditions of the heating device 3 can be determined, thereby adjusting the heat quantity of the first induction coil 31a and the second induction coil 31b. The user's cooking option includes for example a powering off selective item, a powering on selective item, a heat quantity selective item, a heating time selective item, a fast heating selective item or a slow heating selective item.

In this embodiment, the user interface unit 32 comprises two operating elements 32a and 32b. The operating elements 32a and 32b are button-type operating elements or rotary operating elements. By manipulating the operating elements 32a and 32b, the cooking conditions of the heating device 3 are determined. In some embodiments, the user interface unit 32 is a touch screen for implementing the user's cooking option. In addition, the present operating information (e.g. on status, off status, present heat quantity, heating time, slow heating mode or fast heating mode) can be shown on the touch screen.

As shown in FIG. 2, even if a large-sized foodstuff container 4 is placed on the heating region B1 of the heating device 3, the foodstuff container 4 is effectively aligned with the first induction coil 31a and the second induction coil 31b so that the foodstuff container 4 is heated by the first induction coil 31a and the second induction coil 31b simultaneously. Since the first induction coil 31a and the second induction coil 31b are concentric with each other, the first induction coil 31a and the second induction coil 31b are defined as an equivalent induction coil for generating more heat quantity or power. In such way, the heating efficacy of the first induction coil 31a and the second induction coil 31b will be enhanced. Moreover, the total heat quantity of the first induction coil 31a and the second induction coil 31b will be employed to heat the foodstuff container 4 through electromagnetic induction.

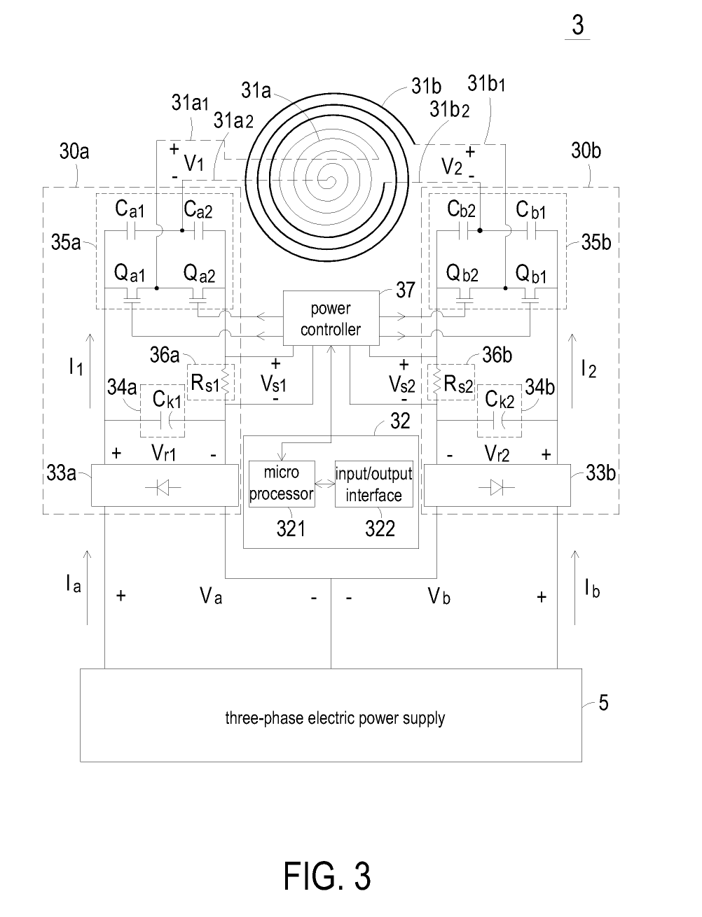

FIG. 3 is a schematic circuit block diagram illustrating a heating device with plural induction coils according to an embodiment of the present invention. As shown in FIG. 3, the heating device 3 comprises a first induction coil 31a, a second induction coil 31b, a user interface unit 32, a first rectifier circuit 33a, a second rectifier circuit 33b, a first filtering circuit 34a, a second filtering circuit 34b, a first inverter circuit 35a, a second inverter circuit 35b, a first current-detecting circuit 36a, a second current-detecting circuit 36b and a power controller 37. The first rectifier circuit 33a, the first filtering circuit 34a, the first inverter circuit 35a and the first current-detecting circuit 36a constitute a first phase power unit 30a. The first phase power unit 30a is configured for receiving a first phase input voltage Va and outputting a first voltage V1 to the first induction coil 31a so that the foodstuff container 4 is heated by the first induction coil 31a through electromagnetic induction.

Similarly, the second rectifier circuit 33b, the second filtering circuit 34b, the second inverter circuit 35b and the second current-detecting circuit 36b constitute a second phase power unit 30b. The second phase power unit 30b is configured for receiving a second phase input voltage Vb and outputting a second voltage V2 to the second induction coil 31b so that the foodstuff container 4 is heated by the second induction coil 31b through electromagnetic induction.

In this embodiment, the heating device 3 uses a single power controller 37 to simultaneously control the first phase power unit 30a and the second phase power unit 30b. In addition, the power controller 37 is connected with the circuit board of the user interface unit 32 through connecting wires. Consequently, the operating data of the first phase power unit 30a and the second phase power unit 30b can be acquired by the user interface unit 32. For example, the operating data includes the operating frequencies of the first voltage V1 and the second voltage V2. The use of the single power controller 37 can reduce the overall cost of the heating device 3. The user interface unit 32 can use simple algorithm to control the power controller 37 while increasing the stability. In some embodiments, the first phase power unit 30a, the second phase power unit 30b and the power controller 37 are mounted on the same circuit board, so that the stability is enhanced.

In this embodiment, the first rectifier circuit 33a and second rectifier circuit 33b are bridge rectifier circuits. The input terminals of the first rectifier circuit 33a and second rectifier circuit 33b are respectively connected with two phases of a three-phase electric power supply 5 through power wires, thereby receiving the first phase input voltage Va and the second phase input voltage Vb of the three-phase power source. By the first rectifier circuit 33a and the second rectifier circuit 33b, the first phase input voltage Va and the second phase input voltage Vb are respectively rectified into a first phase rectified voltage Vr1 and a second phase rectified voltage Vr2. Since the phase difference between the first phase input voltage Va and the second phase input voltage Vb is 120 degrees, the currents flowing through the power wires are reduced when compared with a conventional heating device using a single phase input power supply. The heating device 3 of the present invention can provide more heat quantity or power to the first induction coil 31a and the second induction coil 31b. For example, if the maximum allowable values of a first phase input current Ia and a second phase input current Ib are 10 A (ampere), the maximum heat quantity or power of the heating device 3 will be increased when compared with the conventional heating device using a single phase input power supply whose maximum allowable input current value is also 10 A.

In this embodiment, the first filtering circuit 34a is connected with the output terminal of the first rectifier circuit 33a. The second filtering circuit 34b is connected with the output terminal of the second rectifier circuit 33b. The first filtering circuit 34a and the second filtering circuit 34b are used for filtering off the high-frequency components contained in the first phase rectified voltage Vr1 and the second phase rectified voltage Vr2. In this embodiment, the first filtering circuit 34a comprises a first filter capacitor Ck1, and the second filtering circuit 34b comprises a second filter capacitor Ck2.

In this embodiment, the first inverter circuit 35a comprises a first switch element Qa1, a second switch element Qa2, a first capacitor Ca1 and a second capacitor Ca2. The first switch element Qa1 and the second switch element Qa2 are connected with each other in series. A first connecting node between the first switch element Qa1 and the second switch element Qa2 is connected with a first end 31a1 of the first induction coil 31a. The first capacitor Ca1 and the second capacitor Ca2 are connected with each other in series. A second connecting node between the first capacitor Ca1 and the second capacitor Ca2 is connected with a second end 31a2 of the first induction coil 31a. The power controller 37 is connected with the control terminals of the first switch element Qa1 and the second switch element Qa2. Under control of the power controller 37, the first switch element Qa1 and the second switch element Qa2 are conducted in an interleaved manner. As such, a first AC voltage V1 is generated by the first inverter circuit 35a. In a case that the first switch element Qa1 is conducted but the second switch element Qa2 is shut off, the electric energy of the first phase rectified voltage Vr1 is successively transmitted through the first switch element Qa1 and the second capacitor Ca2 to the first induction coil 31a. In a case that the second switch element Qa2 is conducted but the first switch element Qa1 is shut off, the electric energy of the first phase rectified voltage Vr1 is successively transmitted through the first capacitor Ca1 and the second switch element Qa2 to the first induction coil 31a.

Similarly, the second inverter circuit 35b comprises a third switch element Qb1, a fourth switch element Qb2, a third capacitor Cb1 and a fourth capacitor Cb2. The third switch element Qb1 and the fourth switch element Qb2 are connected with each other in series. A third connecting node between the third switch element Qb1 and the fourth switch element Qb2 is connected with a first end 31b1 of the second induction coil 31b. The third capacitor Cb1 and the fourth capacitor Cb2 are connected with each other in series. A fourth connecting node between the third capacitor Cb1 and the fourth capacitor Cb2 is connected with a second end 31b2 of the second induction coil 31b. The power controller 37 is connected with the control terminals of the third switch element Qb1 and the fourth switch element Qb2. Under control of the power controller 37, the third switch element Qb1 and the fourth switch element Qb2 are conducted in an interleaved manner. As such, a second AC voltage V2 is generated by the second inverter circuit 35b. In a case that the third switch element Qb1 is conducted but the fourth switch element Qb2 is shut off, the electric energy of the second phase rectified voltage Vr2 is successively transmitted through the third switch element Qb1 and the fourth capacitor Cb2 to the second induction coil 31b. In a case that the fourth switch element Qb2 is conducted but the third switch element Qb1 is shut off, the electric energy of the second phase rectified voltage Vr2 is successively transmitted through the third capacitor Cb1 and the fourth switch element Qb2 to the second induction coil 31b.

In this embodiment, the first current-detecting circuit 36a comprises a first detecting resistor Rs1. Alternatively, the first current-detecting circuit 36a is a current transformer or Hall current sensor. The first current-detecting circuit 36a is interconnected between the first filtering circuit 34a and the first inverter circuit 35a for detecting a first current I1 flowing through the first inverter circuit 35a, and generating a corresponding first current-detecting signal Vs1 to the power controller 37.

In this embodiment, the second current-detecting circuit 36b comprises a second detecting resistor Rs2. Alternatively, the second current-detecting circuit 36b is a current transformer or Hall current sensor. The second current-detecting circuit 36b is interconnected between the second filtering circuit 34b and the second inverter circuit 35b for detecting a second current 12 flowing through the second inverter circuit 35b, and generating a corresponding second current-detecting signal Vs2 to the power controller 37.

According to the first current-detecting signal Vs1 and the second current-detecting signal Vs2, the power controller 37 will judge whether the power (watt) of the first induction coil 31a and the second induction coil 31b exceeds a rated value. If the power of the first induction coil 31a and the second induction coil 31b exceeds the rated value, the power of the first inverter circuit 35a outputted to the first induction coil 31a and the power of the second inverter circuit 35b outputted to the second induction coil 31b will be reduced.

In this embodiment, the user interface unit 32 comprises a micro processor 321 and an input/output interface 322. The micro processor 321 is interconnected between the power controller 37 and the input/output interface 322. Through the input/output interface 322, a user's cooking option corresponding to the heating conditions of the heating device 3 can be determined. According to the user's cooking option, the micro processor 321 will control the power controller 37 to adjust the operating statuses of the first induction coil 31a and the second induction coil 31b. In this embodiment, the input/output interface 322 is a touch screen for implementing the user's cooking option. In addition, the present operating information can be shown on the touch screen. In a case that the first induction coil 31a and the second induction coil 31b are simultaneously enabled, the micro processor 321 will control the power controller 37 to control operations of the first inverter circuit 35a and the second inverter circuit 35b, thereby generating the first voltage V1 and the second voltage V2, respectively. Since the first voltage V1 and the second voltage V2 are in-phase, co-frequency or synchronous, the possibility of generating interference will be minimized.

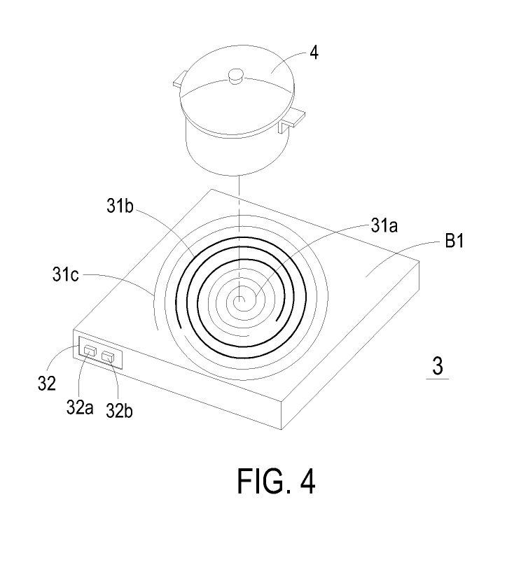

FIG. 4 is a schematic diagram illustrating a heating device with plural induction coils according to another embodiment of the present invention. As shown in FIG. 4, the heating device 3 comprises a first induction coil 31a, a second induction coil 31b, a third induction coil 31c and a user interface unit 32. In comparison with the heating device 3 of FIG. 2, the heating device 3 of FIG. 4 further comprises the third induction coil 31c and the heat quantity of the heating device 3 of FIG. 4 is relatively higher. In an embodiment, the first induction coil 31a, the second induction coil 31b and the third induction coil 31c aren't always concentric with each other. Alternatively, the first induction coil 31a, the second induction coil 31b and the third induction coil 31c are concentric with each other. The first induction coil 31a is surrounded by the second induction coil 31b, and the second induction coil 31b is surrounded by the third induction coil 31c. When the foodstuff container 4 is heated by the first induction coil 31a, the second induction coil 31b and the third induction coil 31c simultaneously, the heat quantity is substantially equal to the total of respective heat quantities of the first induction coil 31a, the second induction coil 31b and the third induction coil 31c.

For example, in an embodiment, the first phase input voltage Va, the second phase input voltage Vb and the third phase input voltage Vc are all 230 volts; and the maximum allowable values of a first phase input current Ia, a second phase input current Ib and a third phase input current Ic are all 16 A (ampere). If the maximum allowable value of the input current of the conventional heating device using the single phase input power supply is also 16 A, the maximum heat quantity or power is only 3600 watts. Whereas, the maximum heat quantity or power generated by each of the first induction coil 31a, the second induction coil 31b and the third induction coil 31c is 3600 watts. As a consequence, the maximum heat quantity or power provided by the heating device 3 of the present invention is increased to 10800 watts, which is three times the heat quantity or power of the conventional heat device.

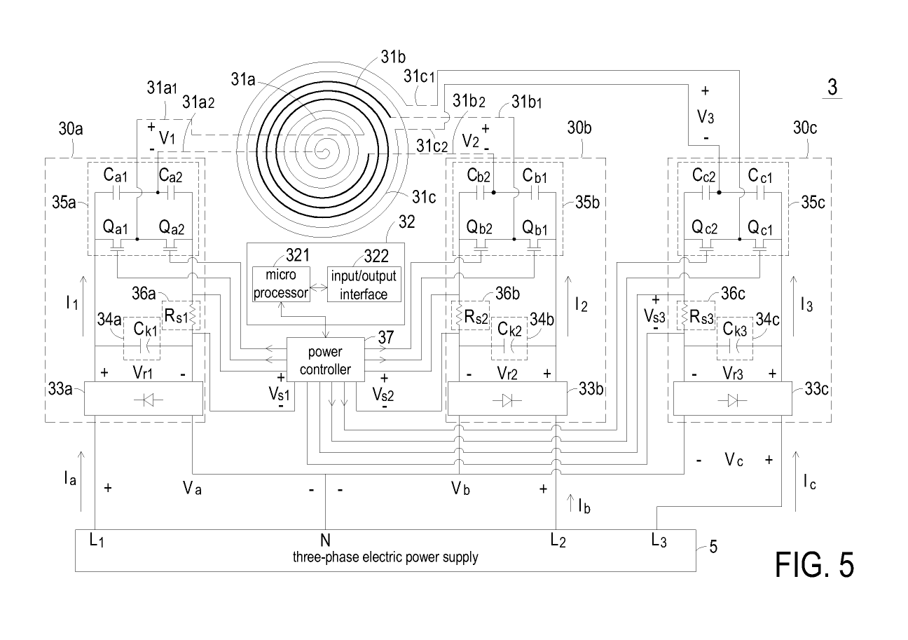

FIG. 5 is a schematic circuit block diagram illustrating a heating device with plural induction coils according to another embodiment of the present invention. In comparison with the heating device 3 of FIG. 3, the heating device 3 of FIG. 5 further comprises a third induction coil 31c, a third rectifier circuit 33c, a third filtering circuit 34c, a third inverter circuit 35c and a third current-detecting circuit 36c. Similarly, the third rectifier circuit 33c, the third filtering circuit 34c, the third inverter circuit 35c and the third current-detecting circuit 36c constitute a third phase power unit 30c. The third phase power unit 30c is configured for receiving a third phase input voltage Vc and outputting a third voltage V3 to the third induction coil 31c so that the foodstuff container 4 is heated by the third induction coil 31c through electromagnetic induction.

In this embodiment, the input side of the first rectifier circuit 33a is connected with a first line terminal L1 and a neutral terminal N of the three-phase electric power supply 5. The input side of the second rectifier circuit 33b is connected with a second line terminal L2 and the neutral terminal N of the three-phase electric power supply 5. The input side of the third rectifier circuit 33c is connected with a third line terminal L3 and the neutral terminal N of the three-phase electric power supply 5. By the first rectifier circuit 33a, second rectifier circuit 33b and the third rectifier circuit 33c, the first phase input voltage Va, the second phase input voltage Vb and the third phase input voltage Vc are respectively rectified into a first phase rectified voltage Vr1, a second phase rectified voltage Vr2 and a third phase rectified voltage Vr3.

Since the phase difference between every two of the first phase input voltage Va, the second phase input voltage Vb and the third phase input voltage Vc is 120 degrees, the heat device 3 of the present invention can provide more heat quantity or power when compared with a conventional heating device using a single phase input power supply. In this embodiment, the first phase input voltage Va, the second phase input voltage Vb and the third phase input voltage Vc are equal to the phase voltages that are provided by the three-phase electric power supply 5. Alternatively, the first phase input voltage Va, the second phase input voltage Vb and the third phase input voltage Vc are equal to the line voltages that are provided by the three-phase electric power supply 5.

In this embodiment, the third filtering circuit 34c comprises a third filter capacitor Ck3. The third current-detecting circuit 36c comprises a third detecting resistor Rs3. The third current-detecting circuit 36c is used for detecting a third current I3 flowing through the third inverter circuit 35c, and generating a corresponding third current-detecting signal Vs3 to the power controller 37.

Similarly, the third inverter circuit 35c comprises a fifth switch element Qc1, a sixth switch element Qc2, a fifth capacitor Cc1 and a sixth capacitor Cc2. The fifth capacitor Cc1 and the sixth capacitor Cc2 are connected with each other in series. A fifth connecting node between the fifth switch element Qc1 and the sixth switch element Qc2 is connected with a first end 31c1 of the third induction coil 31c. The fifth capacitor Cc1 and the sixth capacitor Cc2 are connected with each other in series. A sixth connecting node between the fifth capacitor Cc1 and the sixth capacitor Cc2 is connected with a second end 31c2 of the third induction coil 31c. The power controller 37 is connected with the control terminals of the fifth switch element Qc1 and the sixth switch element Qc2. Under control of the power controller 37, the fifth switch element Qc1 and the sixth switch element Qc2 are conducted in an interleaved manner. As such, a third AC voltage V3 is generated by the third inverter circuit 35c. In a case that the fifth switch element Qc1 is conducted but the sixth switch element Qc2 is shut off, the electric energy of the third phase rectified voltage Vr3 is successively transmitted through the fifth switch element Qc1 and the sixth capacitor Cc2 to the third induction coil 31c. In a case that the sixth switch element Qc2 is conducted but the fifth switch element Qc1 is shut off, the electric energy of the third phase rectified voltage Vr3 is successively transmitted through the fifth capacitor Cc1 and the sixth switch element Qc2 to the third induction coil 31c.

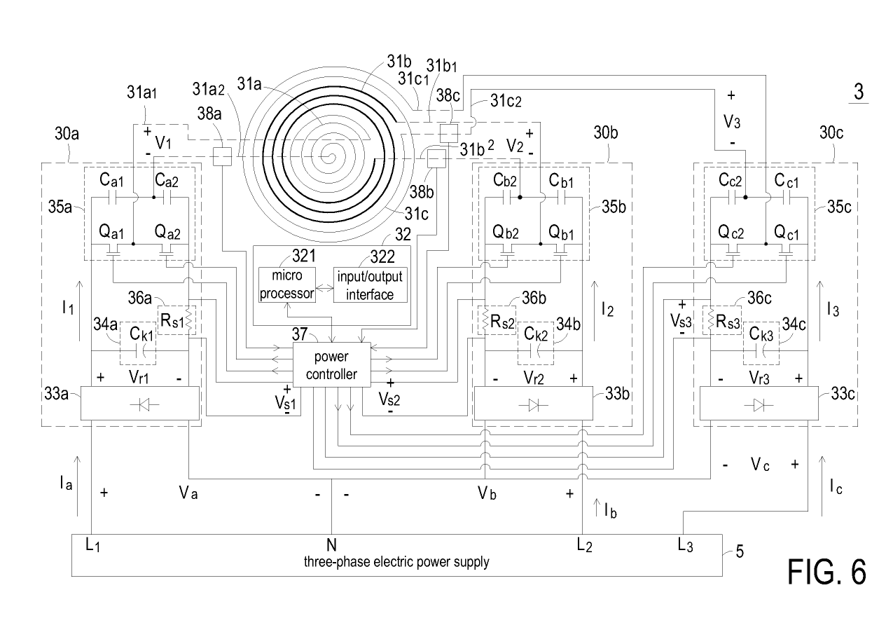

FIG. 6 is a schematic circuit block diagram illustrating a heating device with plural induction coils according to another embodiment of the present invention. In comparison with the heating device 3 of FIG. 5, the heating device 3 of FIG. 6 further comprises a first coil current-detecting circuit 38a, a second coil current-detecting circuit 38b and a third coil current-detecting circuit 38c. The first coil current-detecting circuit 38a is serially connected with the first induction coil 31a for detecting the current flowing through the first induction coil 31a. The second coil current-detecting circuit 38b is serially connected with the second induction coil 31b for detecting the current flowing through the second induction coil 31b. The third coil current-detecting circuit 38c is serially connected with the third induction coil 31c for detecting the current flowing through the third induction coil 31c. An example of each of the coil current-detecting circuits 38a, 38b and 38c includes but is not limited to a current transformer (CT) or Hall current sensor.

The currents flowing through the first induction coil 31a, the second induction coil 31b and the third induction coil 31c are respectively detected by the first coil current-detecting circuit 38a, the second coil current-detecting circuit 38b and the third coil current-detecting circuit 38c, and acquired by the power controller 37. The information associated with these currents will be transmitted from the power controller 37 to the micro processor 321. According to the currents flowing through the first induction coil 31a, the second induction coil 31b and the third induction coil 31c, the micro processor 321 will judge a size of the foodstuff container 4. According to the size of the foodstuff container 4, the micro processor 321 will enable at least one of the first phase power unit 30a, the second phase power unit 30b and the third phase power unit 30c, thereby selectively controlling operations of the first induction coil 31a, the second induction coil 31b and the third induction coil 31c.

For example, for heating a large-size foodstuff container 4, the micro processor 321 will control the power controller 37 to enable the first phase power unit 30a, the second phase power unit 30b and the third phase power unit 30c. For heating a medium-size foodstuff container 4, the micro processor 321 will control the power controller 37 to enable the first phase power unit 30a and the second phase power unit 30b but disable the third phase power unit 30c. For heating a small-size foodstuff container 4, the micro processor 321 will control the power controller 37 to enable the first phase power unit 30a but disable the second phase power unit 30b and the third phase power unit 30c

Similarly, in a case that the first induction coil 31a, the second induction coil 31b and the third induction coil 31c are simultaneously enabled, the micro processor 321 will control the power controller 37 to control operations of the first inverter circuit 35a, the second inverter circuit 35b and the third inverter circuit 35c, thereby generating the first voltage V1, the second voltage V2 and the third voltage V3, respectively. Since the first voltage V1, the second voltage V2 and the third voltage V3 are in-phase, co-frequency or synchronous, the possibility of generating interference will be minimized.

In this embodiment, the micro processor 321 will control the power controller 37 to adjust the operating frequency (e.g. 20k-50 kHz) of the first switch element Qa1, the second switch element Qa2, the third switch element Qb1, the fourth switch element Qb2, the fifth switch element Qc1 and the sixth switch element Qc2. Consequently, the heat quantity provided to the foodstuff container 4 by the first induction coil 31a, the second induction coil 31b and the third induction coil 31c will be adjusted.

In the above embodiments, an example of the power controller 37 includes but is not limited to a pulse frequency modulation (PFM) controller or a digital signal processor (DSP). The first switch element Qa1, the second switch element Qa2, the third switch element Qb1, the fourth switch element Qb2, the fifth switch element Qc1 and the sixth switch element Qc2 are metal oxide semiconductor field effect transistors (MOSFETs), bipolar junction transistors (BJTs) or insulated gate bipolar transistors (IGBTs).

From the above description, since the heating device of the present invention uses a multi-phase input power supply, the heat device of the present invention can provide more heat quantity or power when compared with a conventional heating device using a single phase input power supply. The heating device of the present invention can provide more heat quantity or power to the induction coils because the currents flowing through the power wires are reduced. Moreover, since all phase power units are controlled by a single power controller, the operating data of all phase power units can be acquired by the user interface unit. The use of the single power controller can reduce the overall cost of the heating device. The user interface unit can use simple algorithm to control the power controller while increasing the stability.

Moreover, the induction coils are arranged on the same heating region. Since the large-sized foodstuff container is effectively aligned with the induction coils, the foodstuff container can be heated by the induction coils simultaneously. These induction coils are collectively defined as an equivalent induction coil for generating more heat quantity or power. In such way, the heating efficacy of the induction coils will be enhanced. Moreover, the total heat quantity of the induction coils will be employed to heat the foodstuff container through electromagnetic induction.

Moreover, according to the size of the foodstuff container, the micro processor of the heating device will enable at least one of the first phase power unit, the second phase power unit and the third phase power unit, thereby selectively controlling operations of the first induction coil, the second induction coil and the third induction coil. Therefore, the heating device of the present invention can be used to heat various foodstuff containers with different sizes.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A heating device, comprising:
a first induction coil;
a second induction coil;
a first phase power unit connected with said first induction coil, and configured for receiving a first phase input voltage and outputting a first voltage;
a second phase power unit connected with said second induction coil, and configured for receiving a second phase input voltage and outputting a second voltage, wherein there is a phase difference between said first phase input voltage and said second phase input voltage;
a power controller connected with said first phase power unit and said second phase power unit for controlling operations of said first phase power unit and said second phase power unit; and
a user interface unit connected with said power controller for controlling said power controller.

2. The heating device according to claim 1, wherein said user interface unit comprises:
an input/output interface for inputting a user's cooking option corresponding to heating conditions of said heating device and outputting an operating information of said heating device; and
a micro processor for controlling said power controller to adjust heat quantity of said first induction coil and said second induction coil according to said user's cooking option.

3. The heating device according to claim 1, further comprising:
a first coil current-detecting circuit serially connected with said first induction coil for detecting a current flowing through said first induction coil; and
a second coil current-detecting circuit serially connected with said second induction coil for detecting a current flowing through said second induction coil, wherein said user interface unit judges a size of a foodstuff container according to said currents flowing through said first induction coil and said second induction coil and selectively enables at least one of said first phase power unit and said second phase power unit according to said size of said foodstuff container, thereby selectively controlling operations of said first induction coil and said second induction coil.

4. The heating device according to claim 1, wherein said first voltage and said second voltage are in-phase, co-frequency or synchronous.

5. The heating device according to claim 1, wherein said first phase power unit, said second phase power unit and said power controller are mounted on the same circuit board.

6. The heating device according to claim 1, wherein said first phase power unit comprises:
a first rectifier circuit for receiving said first phase input voltage and rectifying said first phase input voltage into a first phase rectified voltage;
a first filtering circuit connected with an output terminal of said first rectifier circuit for filtering off high-frequency components contained in said first phase rectified voltage; and
a first inverter circuit connected with said first rectifier circuit and said power controller, wherein said first rectifier circuit is controlled by said power converter to generate said first voltage to said first induction coil.

7. The heating device according to claim 6, wherein said first phase power unit further comprises a first current-detecting circuit, which is interconnected between said first filtering circuit and said first inverter circuit for detecting a first current flowing through said first inverter circuit, and generating a corresponding first current-detecting signal to said power controller.

8. The heating device according to claim 1, wherein said second phase power unit comprises:
a second rectifier circuit for receiving said second phase input voltage and rectifying said second phase input voltage into a second phase rectified voltage;
a second filtering circuit connected with an output terminal of said second rectifier circuit for filtering off high-frequency components contained in said second phase rectified voltage; and
a second inverter circuit connected with said second rectifier circuit and said power controller, wherein said second rectifier circuit is controlled by said power converter to generate said second voltage to said second induction coil.

9. The heating device according to claim 8, wherein said second phase power unit further comprises a second current-detecting circuit, which is interconnected between said second filtering circuit and said second inverter circuit for detecting a second current flowing through said second inverter circuit, and generating a corresponding second current-detecting signal to said power controller.

10. The heating device according to claim 1, further comprising:
a third induction coil; and
a third phase power unit connected with said third induction coil, and configured for receiving a third phase input voltage and outputting a third voltage, wherein there is a phase difference between every two of said first phase input voltage, said second phase input voltage and said third phase input voltage.
